(19) United States
(12) Patent Application Publication
(10) Pub. No.: US 2013/0209617 A1
(43) Pub. Date: Aug. 15, 2013

(54) COMPOSITIONS AND METHODS FOR USE IN PROMOTING PRODUCE HEALTH

(71) Applicants: George Lobisser, Bainbridge Island, WA (US); Jason Alexander, Yakima, WA (US); Matt Weaver, Selah, WA (US)

(72) Inventors: George Lobisser, Bainbridge Island, WA (US); Jason Alexander, Yakima, WA (US); Matt Weaver, Selah, WA (US)

(73) Assignee: PACE INTERNATIONAL, LLC, Seattle, WA (US)

(21) Appl. No.: 13/571,513

(22) Filed: Aug. 10, 2012

Related U.S. Application Data
(60) Provisional application No. 61/522,061, filed on Aug. 10, 2011.

(51) Int. Cl. A23B 7/16

(52) U.S. Cl. CPC A23B 7/16
USPC 426/102; 426/654; 426/573; 426/601; 426/321

(57) ABSTRACT

Provided herein are compositions comprising one or more of a stilbenoid, stilbenoid derivative, stilbene, or stilbene derivative and a produce coating. The resulting compositions are coatings which promote the health of fruit, vegetables, and/or other plant parts, and/or mitigate decay of post-harvest fruit, vegetables, and/or other plant parts.

### RELATED APPLICATIONS

This application claims priority under 35 U.S.C. 119 (e) to U.S. Provisional Patent Application Ser. No. 61/522,061, entitled “COMPOSITIONS AND METHODS FOR USE IN PROMOTING PRODUCE HEALTH”, filed Aug. 10, 2011, the disclosure of which is hereby incorporated by reference in its entirety.

### FIELD

This disclosure relates to produce coatings, and in particular, produce coatings which promote the health of fruit, vegetables, and/or other plant parts, and/or mitigate decay of post-harvest fruit, vegetables, and/or other plant parts.

### BACKGROUND

The statements in this section merely provide background information related to the present disclosure and may not constitute prior art.

Most fruit and vegetable products are harvested in a fairly narrow time period or season. However, consumer demand remains high for fresh produce out of season. Often, fresh produce is transported hundreds of miles from the initial site of harvest and stored for many months after harvest. For these reasons, it is desirable to extend produce shelf-life.

The typical shelf-life of a fruit or vegetable (fresh produce) depends on several factors including ripeness at time of harvest, handling conditions, and storage conditions.

A common method for extending the post-harvest storage of fruit and vegetables is the use of edible coatings. Most fruits are susceptible to post-harvest deterioration brought about by water loss, gas exchange, bruising, mechanical injury, and microbial growth.

U.S. Pat. No. 3,847,641 to Cushman et al. purportedly mentions wax emulsion compositions for controlling transpiration in plants.

U.S. Pat. No. 5,019,403 to Krochta purportedly mentions coating compositions for substrates such as edible agricultural products.

U.S. Pat. No. 6,482,455 to Freire et al. purportedly mentions compositions for the control of post-harvest pathologies of fruits and vegetables.

Further effort is needed to find coatings which improve produce health or mitigate decay of post-harvest fruits, vegetables, and other plant parts, leading to a longer storage life while maintaining quality sensory traits.

The present invention is directed toward overcoming one or more of the problems discussed above.

### BRIEF DESCRIPTION OF THE DRAWINGS

The drawings described herein are for illustration purposes only and are not intended to limit the scope of the present disclosure in any way.

FIG. 1 shows Percent weight loss for Gala apples. UTC is the untreated control (no coating applied).

FIG. 2 shows Creep (CO) values in inches for Gala apples.

FIG. 3 shows Crispness (Cn) values for Gala apples.

FIG. 4 shows Core integrity (E2) values in lbs for Gala apples.

FIG. 5 shows Average firmness in region 1 (A1) values in lbs for Gala apples.

FIG. 6 shows Average Firmness in region 2 (A2) values in lbs for Gala apples. “Initial” indicates value at day zero before coatings were applied.

FIG. 7 shows Maximum firmness in region 1 (M1) values in lbs for Gala apples.

FIG. 8 shows Maximum firmness in region 2 (M2) values in lbs for Gala apples. “Initial” indicates value at day zero before coatings were applied.

FIG. 9 shows Overall average hardness (OAH) values in lbs for Gala apples.

FIG. 10 shows Overall maximum hardness (OMH) values in lbs for Gala apples.

### SUMMARY

Provided herein are compositions useful in the food industry as coatings for fruits, vegetables, and other plants and plant parts. In some embodiments, the compositions comprise a produce coating, e.g. a coating containing shellac or a carnauba wax, and one or more stilbenoid compounds. In some aspects, the stilbenoid compound is a stilbene derivative, a stilbene oligomer, stilbene, a stilbenoid derivative, or a stilbenoid oligomer.

Also provided herein are food products comprising a fruit, vegetable, or other edible plant part having a composition applied to the surface. Useful compositions are disclosed herein, for example, compositions comprising: i) a wax, oil, resin, protein, carbohydrate, phospholipid, gum, silicone, or polydimethysiloxane; and ii) one or more compounds selected from the group consisting of resveratrol, stilbene, pterostilbene, piceid, ε-viniferin, piceatannol, diptoindonesin A, pinosylvin, astringin, vaticanol B, trans-diptoindonesin B, hopeaphenol, hemsleyanol D, gnetin H, ampelopsin A, ampelopsin E, and alpha-viniferein.

Further provided are methods of maintaining health of a fruit, vegetable, or other edible plant part. The methods comprise contacting the surface of the fruit, vegetable, or other edible plant part with a composition comprising a produce coating and one or more stilbenoid compounds. Exemplary compositions are described herein, for example, produce coating compositions comprising one or more stilbenoid compounds such as a stilbene derivative, a stilbene oligomer, stilbene, a stilbenoid derivative, or a stilbenoid oligomer.

Still further methods provided herein include methods of mitigating decay of post-harvest produce and methods of maintaining firmness of post-harvest produce. Compositions described herein are useful in these and other methods as will be understood by one skilled in the art.

Further areas of applicability of the present teachings will become apparent from the description provided herein. It should be understood that the description and specific examples are intended for purposes of illustration only and are not intended to limit the scope of the present teachings.

### DETAILED DESCRIPTION

The following description is merely exemplary in nature and is not intended to limit the present disclosure, application, claims, compositions, or uses.

Disclosed herein are compositions comprising phytoalexins and methods of using those compositions to promote fruit health and/or mitigate decay of post-harvest fruit. In some embodiments, the compositions comprise stilbenes, stilbene derivatives, and/or stilbene oligomers. In some embodiments, the compositions comprise stilbenoids, stilbenoid derivatives, and/or stilbenoid oligomers. In some embodiments, the compositions comprise resveratrol, resveratrol derivatives, and resveratrol oligomers.

Stilbenoids, including for example, stilbene, resveratrol, pterostilbene, piceid, ε-viniferin, piceatannol, and diptoindonesin A, are isomeric hydrocarbon compounds containing an ethene double bond substituted with an unsubstituted or substituted phenyl group on both carbon atoms of the double bond. The term stilbenoid refers to stilbenes, bibenzyls (7,8-dihydrostilbenes), and phenyldihydroisocoumarins together with a number of nitrogen free phenatlirenols, which are thought to be products of the same metabolic pathway that leads to stilbenes. Gorham, J., The Stilbenoids in Progress in Phytochemistry, Vol. 6, Reinhold, et al., eds., Pergamon Press, New York, 1980, pp 203-252. Stilbenes generally have two stereoisomeric forms, a trans- or a cis-skeleton Other stilbenoids include but are not limited to pinosylvin, astringin, vaticanol B, trans-diptoindonesin B, diptoindonesin C, diptoindonesin F, hopeaphenol, hemsleyanol D, hemsleyanosides A-D, gnetin H, ampelopsin A, ampelopsin E, rhaponticin, alpha-viniferein, flexuosol A, gnetupendin C, gnetin D, resveratroloside, agrostophyllin, agrostophyllone, agrostophylloxin, agrostophylloxidin, and agrostophyllidin. Further contemplated are stilbene and stilbene derivatives and stilbene oligomers, stilbenoids (hydroxylated derivatives of stilbene) and stilbenoid derivatives and stilbenoid oligomers. Illustratively, resveratrol and resveratrol oligomers and reservatrol derivatives are contemplated herein. Such compounds can be considered phytoalexins, a chemical class of compounds produced by plants for defense purposes.

Generally, naturally occurring stilbenes and bibenzyls are hydroxy and/or methoxy substituted at the 3,3′,4,4′,5, and 5′ positions. Some naturally occurring stilbenes and bibenzyls include pinosylvin (3,5 -dihydroxy stilbene), piceatannol (3,3′,4,5′-tetrahydroxlystilbene), piceid (3,4′,5-trihydroxystilbene-3-0-.beta.-D-glucopyranoside) and resveratrol (3,4′5-trihydroxystilbene). Mono-(3 -hydroxy-5-methoxystilbene) and di-methyl (3,5-dimethoxystilbene) ethers of trans-pinosylvin and their respective dihydroderivatives have been reported isolated from the heartwood of Pinus armandi, P. morrisonicola, and P. parviflorai. Fang, J-M, et al., Phytochemistry 27(5): 1395-1397 (1988).

Stilbenoids may also be prenylated or homogeranylated at the 2 and 4 (4 and 6) positions. 4-isopentenylresveratrol (3,4′,5-trihydroxy-4-(3-methyl-2-butenyl)stilbene) was isolated from Arachis hypogea (Keen, N. T., et al., Phytochemistry 15, 1794 (1976)). A prenylated pinosylvin dimethyl ether (3,5-dimethoxy-4-(3-methyl-2-butenyl)stilbene) was isolated from Derris rariflora (Braz Filho, R., et al., Phytochemistry 14, 261 (1975a)) and D. floribunda (Braz Filho, R., et al, Phytochemistry 14, 1454 (1975b)). A prenylated resveratrol trimethyl ether (3,4′,5-trimethoxy-4-(3-methyl-2-butenyl)stilbene) was also reported isolated from D. floribunda (Braz Filho, R., et al., 1975b). Chlorophorin (4-homogeranyl-2,3′,4,5′-tetrahydoxystilbene) was isolated from Chlorophora excelsa (Grundon, M. F., et al., Nature (Lond.) 163, 154 (1949)). The occurrence in plants of isoprenice chains substituted stilbenes has also been reported by King and Grundo (J. Chem. Soc. 1950, 3547 (1950)), Cooksey (Cooksey, C. J., et al., Phytochemistry 21(12), 2935 (1982)) and Monache (Lloydia 40(2): 201-208 (1977)).

Stilbenoid-2-carboxylic acid derivatives have been isolated from various plants. Hydrangeic acid (3,4′-dihydroxystilbene-2-carboxylic acid) was reported isolated from the common garden hydrangea (Hydrangeqa macrophylla) Pryce, R. J., Phytochemistry 10, 2679 (1971). A glycoside, gaylussacin, reported isolated from Gaylussacia frondosa, and G. vassata (Ericaceae), produced a 3,5-dihydroxystilbene-2-carboxylic acid derivative (gaylussacin aglycone). Askari, A., et al., Lloydia 35,49 (1972).

Four isoprenylated stilbene 2-carboxylic acid phytoalexins (3-hydroxy-5-methoxy-6-(3-methyl-2-butenyl) stilbene-2-carboxylic acid, 3-hydroxy-5-methoxy-4-(3-methyl-2-butenyl)stilbene-2-carboxylic acid, 3,5-dimethoxy-6-(3- methyl-2-butenyl)stilbene-2-carboxylic acid, and 3,5-dimethoxy-4-(3-methyl-2-butenyl)stilbene-2-carboxylic acid) were reported isolated from the leaves of Canjanus cajan challenged with Botrytis cinerea (Cooksey, C J, et al., Phytochemistry 21(12):2935-2938 (1982). Other stilbene compounds isolated from the Cajanus spp. include 3-hydroxy-4-isoprenyl-5-methoxystilbene-2-carboxylic acid; 3-hydroxy-6-isoprenyl-5-methoxystilbene-2-carboxylic acid; 3,5-dimethoxy-4-isoprenylstilbene-2-carboxylic acid; and 3,5-dimethoxy-6-isoprenylstilbene-2-carboxylic acid.

Other stilbene derivatives include but are not limited to hydrangeic acid (3,4′-dihydroxystilbene-2-carboxylic acid); gaylussacin aglycone (3,5-dihydroxystilbene-2-carboxylic acid); lunularic acid (3,4′-dihydroxybibenzyl-2-carboxylic acid); 3,5-dihydroxy-4-(3-methyl-2-butenyl)-7,8-dihydrostilbene-2-carboxylic acid; and 4-isopentyl-3,5-dimethoxybibenzyl-2-carboxylic acid.

These compounds, classes of compounds, and groups of compounds as discussed throughout this disclosure can be interchangeable with each other.

Compounds such as stilbenoids, stilbenes, and derivatives of such can be present in the composition in an amount sufficient to promote the health of fruit, vegetables, and/or other plant parts, and/or mitigate decay of post-harvest fruit, vegetables, and/or other plant parts. In some embodiments, the compound can be present in an amount from about 0.001% to about 30% by weight of the composition, for example, about 0.001%, about 0.002%, about 0.003%, about 0.004%, about 0.005%, about 0.006%, about 0.007%, about 0.008%, about 0.009%, about 0.01%, about 0.02%, about 0.03%, about 0.04%, about 0.05%, about 0.06%, about 0.07%, about 0.08%, about 0.09%, about 0.1%, about 0.15%, about 0.2%, about 0.25%, about 0.3%, about 0.35%, about 0.4%, about 0.45%, about 0.5%, about 0.55%, about 0.6%, about 0.65%, about 0.7%, about 0.75%, about 0.8%, about 0.85%, about 0.9%, about 0.95%, about 1.0%, about 1.1%, about 1.2%, about 1.3%, about 1.4%, about 1.5%, about 1.6%, about 1.8%, about 2.0%, about 2.2%, about 2.4%, about 2.6%, about 2.8%, about 3.0%, about 3.2%, about 3.4%, about 3.6%, about 3.8%, about 4.0%, about 4.2%, about 4.4%, about 4.6%, about 4.8%, about 5%, about 6%, about 7%, about 8%, about 9%, about 10%, about 11%, about 12%, about 13%, about 14%, about 15%, about 16%, about 17.0%, about 18%, about 19%, about 20%, about 21%, about 22%, about 23%, about 24%, about 25%, about 26%, about 27%, about 28%, about 29%, about 30% by weight. Illustratively, the composition can comprise resveratrol in an amount of about 0.001% to about 30% by weight of the composition, or about 0.01% to about 10% by weight of the composition, or about 1% by weight of the composition.

Typically, stilbenoids such as resveratrol are difficult to solubilize in water and other food-grade substances. Stilbenoids including resveratrol oxidize and degrade in aqueous and/or alkaline environments.

As used herein, the phrase “to promote fruit health” indicates a maintenance of the physiology of a fruit or vegetable as close to the physiology of the fruit or vegetable at the time of harvest. Compositions disclosed herein can be applied prior to harvest or can be applied during or after harvest to promote fruit health. When discussing “fruit health” it is to be understood that such phrase can also refer to produce health, vegetable health, and/or health of other plant parts. For example, it is contemplated that the compositions disclosed herein are useful in preserving flowers, including cut flowers used in floral arrangements or during storage and transportation.

As used herein, the phrase “to mitigate decay of post-harvest produce” means to reduce, lessen, or decrease the amount of decay in post-harvest produce through the use of compositions disclosed herein, relative to the amount of decay in untreated post-harvest produce of the same type, age, and under the same conditions.

Surprisingly, it has been determined that one or more stilbenes, for example, resveratrol, when placed in contact with the surface of produce, positively and unexpectedly enhances the health of the produce; further, when placed into contact with the surface of the produce, positively and unexpectedly mitigates decay of post-harvest produce; and still further, when placed into contact with the surface of the produce, surprisingly maintains the firmness of the produce relative to untreated produce.

The following parameters can be used to determine health of a given fruit, vegetable, or other plant part according to the disclosure herein:

General appearance: produce can be judged by sensory analysis which includes fresh appearance, color, shininess, lack of discoloration or wrinkles, etc.

Weight loss: produce is weighed at zero time of storage and then again at any interval determined to be appropriate for that particular type of produce. Weight loss can be recorded as a percentage referring to an index weight at zero time.

Firmness: produce firmness can be determined by any number of methods, for example by measuring the compression force of a sample using a texture analyzer.

Skin color: measurement of skin color can be performed using a color meter calibrated using a white plate prior to sample analysis. Color changes can be quantified by lightness, from 0=black to 100=white, chroma which represents color saturation from dull to vivid, and hue angle (color wheel, where red-purple is 0°, yellow is 90°, bluish-green is 180°, and blue is)270°.

Titratable acidity, ascorbic acid, and anthocyanins: titratable acidity is expressed as a percentage of citric acid, citric acid equivalents, malic acid, and malic acid equivalents. Ascorbic acid content is determined by using 2,6-dichlorophenol indophenol titration method. Total anthocyanins were extracted by adding solvent and measuring intensity of the filtered supernatant using a spectrophotometer.

Total sugar and total soluble solids: both can be measured by techniques known to those skilled in the art, such as the refractometric method which employs a refractometer and recorded as percent Brix.

Microbiological analysis: total microbial load and type of contamination can be determined by techniques known to those skilled in the art.

While primarily discussing the compositions and uses thereof in terms of fruit and fruit coatings, it is to be understood that fruit and fruit coatings, respectively, can be interchanged with vegetable and vegetable coatings or produce and produce coatings or plant parts, for example, leaves, stems, roots, flowers, etc. and coatings therefor.

As such, it is contemplated that compositions disclosed herein can be used on fruits such as pome fruits, including for example, apples, pears, quince, etc., stone fruits, including for example, peaches, apricots, nectarines, plums, pluots, apriums, olives, and cherries, citrus fruits, including for example, oranges, blood oranges, lemons, limes, grapefruit, etc., bananas, mangoes, papayas, grapes, kiwis, pomegranate, avocado, pineapple, berries (including blueberries, raspberries, blackberries, boysenberries, strawberries, gooseberries, tayberries, cranberries, barberries, choke berries, lignonberries, marionberries, cloudberries, black current, elderberries, huckleberries, acai berries, goji berries, june berries), and melons; can be used on vegetables including but not limited to asparagus, broccoli, cauliflower, lettuce, celery, spinach, artichoke, onion, tomatoes, peppers, potatoes, carrots, squash, and yams; and can be used on other edible plant parts or plant-like foods such as mushrooms, etc. In general, compositions and methods described herein can be used to protect any type of produce.

Stilbenes, stilbenoids, and like compounds can be formulated into existing produce coatings containing, for example, shellac or carnauba. Illustratively, a shellac coating dissolves relatively high purity resveratrol in a secondary phase. The secondary phase can be a final addition to a shellac-containing primary phase. The secondary phase can be designed to aid in dispersing the resveratrol throughout the shellac phase without falling out of solution.

Stilbenoid compounds can be added to a variety of produce coatings, including but not limited to existing formulations such as DURASHINE™ products, SHIELD-BRITE™ AP products, and PRIMAFRESH™ products.

Illustrative coatings typically used for providing protection or cosmetic enhancement to fruits, vegetables, or other plants or plant parts include naturally occurring compounds, synthetic compounds, or a combination of both. Exemplary naturally occurring compounds include waxes; oils; resins; proteins; carbohydrates (simple and complex); phospholipids; gums; and other film forming compounds of natural origin. Exemplary synthetic compounds include waxes; oils; proteins; carbohydrates (simple and complex); phospholipids; gums; silicones, polydimethysiloxane, and other film forming compounds of synthetic origin. In some embodiments, coatings can be selected from waxes, oils, or resins (or combination of any film-forming compound) of natural or synthetic origin (including but not limited to carnauba wax, beeswax, candelilla wax, rice bran wax, soy wax, banana leaf wax, sunflower oil, olive oil, corn oil, petroleum oil, petrolatum, mineral oil, wood rosin, shellac, natural or synthetic resins, etc.).

Coatings have a variety of compositions, including for example, parafinic (petroleum-oil based), mineral oil, polyethylene-parafinic mixtures, vegetable oil, carnauba oil, and shellacs. Coatings can be classified as aqueous (parafinic, polyethylene, vegetable, and carnauba oil) or non-aqueous (mineral-oil and shellacs). Typically, stone fruit waxes are paraffinic, mineral oil, or vegetable oil based. Some fruits have certain attributes that determine what types of coatings can be used on them, for example, lemons can be stored after picking so both storage and pack waxes can be used on them while oranges cannot be stored after picking so only pack waxes can be used on them. Pack waxes are typically carnauba or shellac-based coatings, providing high shine, reasonable water loss control, and low gas exchange.

Coatings can also include additional agents. In some aspects, the additional agents aid in the application of the coating and/or enhance its efficacy. Such additional agents can include various types of surfactants, emulsifiers, wetting agents, adjuvants, carriers, suspending agents, viscosity modifiers, stabilizers and the like. Illustrative agents include alkanolamides; alkanolamines; alkylaryl sulfonic acid and sulfonates; alkylbenzenes; alkoxylated aryl phenols and alkylphenols; alkoxylated fatty acids, fatty esters, alcohols, and oils; sulfonated amines and amides, betaine derivatives, block polymers, diphenyl sulfonate derivatives, alkoxylated amines and amides; fatty esters; fluorocarbon-based surfactants; imidazoline derivatives; lanolin-based derivatives; lecithin and lecithin derivatives; lignin and lignin derivatives; succinic anhydrides; sulfosuccinates and derivatives; olefin sulfonates; phosphate esters; phosphorous organic derivatives; polymeric (polysaccharides, acrylic acid, acrylamide); protein-based surfactants; silicone-based surfactants; sorbitan derivatives; sucrose and glucose esters and derivatives; sulfates and sulfonates of alkoxylated alkylphenols; oils; fatty acids; alcohols; alkoxylated alcohols; dodecyl and tridecylbenzenes; naphthalene and alkylnapthalene, petroleum; dodecyl and tridecylsulfonic acids.

Fungicide use is taken into consideration when choosing the coating type as some fungicides are incompatible with certain coatings.

Exemplary compositions disclosed herein include shellac produce coatings or caranauba produce coatings with added resveratrol or other stilbenes or stilbenoids. Illustratively, the composition comprises a produce coating and a stilbenoid compound.

In some aspects, the composition comprises a produce coating and only one stilbene or stilbene related compound. In some aspects, the composition comprises a produce coating and only one stilbenoid or stilbenoid related compound. In some aspects, the composition comprises a produce coating and only resveratrol or a resveratrol related compound. In other aspects, the composition comprises a produce coating and one or more of a stilbene, a stilbene related compound, a stilbenoid, a stilbenoid related compound, resveratrol, and/or a resveratrol related compound.

In some aspects, the composition consists essentially of a produce coating and only one stilbene or stilbene related compound. In some aspects, the composition consists essentially of a produce coating and only one stilbenoid or stilbenoid related compound. In some aspects, the composition consists essentially of a produce coating and only resveratrol or a resveratrol related compound. In other aspects, the composition consists essentially of a produce coating and one or more of a stilbene, a stilbene related compound, a stilbenoid, a stilbenoid related compound, resveratrol, and/or a resveratrol related compound.

Compositions described herein can be provided in various formulations for application to produce. For example, the composition can be formulated for application by thermofogging, by drenching, by brushes or rollers, or by spraying or dripping.

Also provided is a food product comprising a fruit, vegetable, or other edible plant part having a composition applied to the surface, wherein the composition comprises (i) a wax, oil, resin, protein, carbohydrate, phospholipid, gum, silicone, polydimethysiloxane, or mixtures thereof; and ii) one or more compounds selected from the group consisting of resveratrol, stilbene, pterostilbene, piceid, ε-viniferin, piceatannol, diptoindonesin A, pinosylvin, astringin, vaticanol B, trans-diptoindonesin B, hopeaphenol, hemsleyanol D, gnetin H, ampelopsin A, ampelopsin E, and alpha-viniferein.

Further provided are methods for maintaining health of a fruit, vegetable, or other plant part. The method comprises contacting the surface of the fruit, vegetable, or other plant part with a composition comprising a produce coating and a stilbenoid compound.

Still further provided are methods for mitigating decay of post-harvest produce. The method comprises contacting the surface of the produce with a composition comprising a produce coating and a stilbenoid compound.

And still further provided are methods for maintaining firmness of produce after harvest. The method comprises contacting the surface of the produce with a composition comprising a produce coating and a stilbenoid compound.

Various aspects of the methods are described above with respect to the compositions. For example, the produce can include any of the above named fruits, vegetables, and/or other plant parts. Likewise, the produce coatings are as described above and the stilbenoid compounds are as described above.

Illustratively, a method for maintaining health of a fruit, vegetable, or other edible plant part comprises contacting the surface of the fruit, vegetable, or other edible plant part with a composition comprising a produce coating and resveratrol; a method of mitigating decay of post-harvest fruit comprises contacting the surface of the fruit with a composition comprising a fruit coating and resveratrol; and a method of maintaining firmness of a stone fruit, a pome fruit, or berries comprises contacting the surface of the stone fruit, pome fruit, or berries with a composition comprising resveratrol and a fruit coating selected from caranauba and shellac.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

### EXAMPLES

The following examples are provided for illustrative purposes only and are not limiting to this disclosure in any way.

### Example 1

### General

Eighteen single apple repetitions were analyzed per treatment per evaluation date. Wax treatments were hand applied to Gala apples and allowed to air dry. The treatments were evaluated after 7 and 14 days of room temperature storage (68° F., 40 to 60% RH), 30 days of refrigerated air storage (34° F., 95 RH), and 30 days of refrigerated air storage followed by 7 days of room temperature storage.

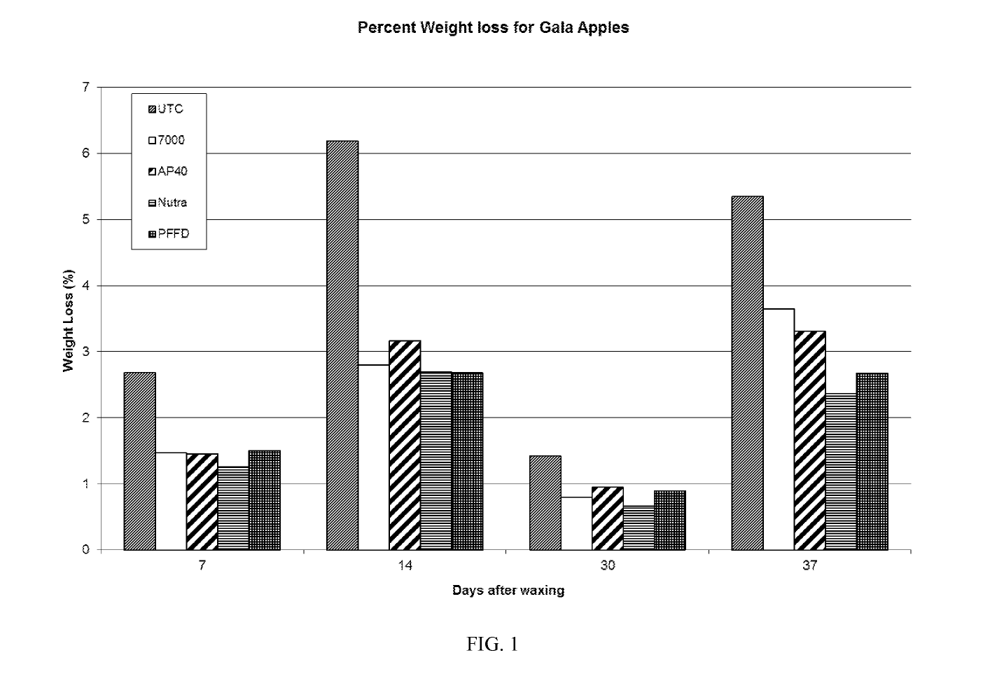

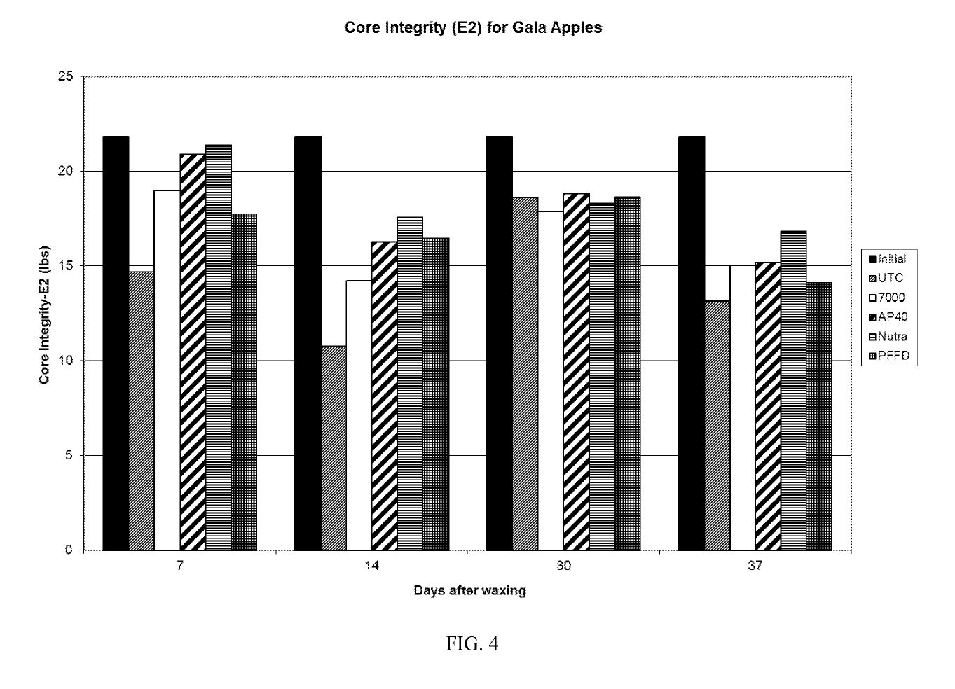

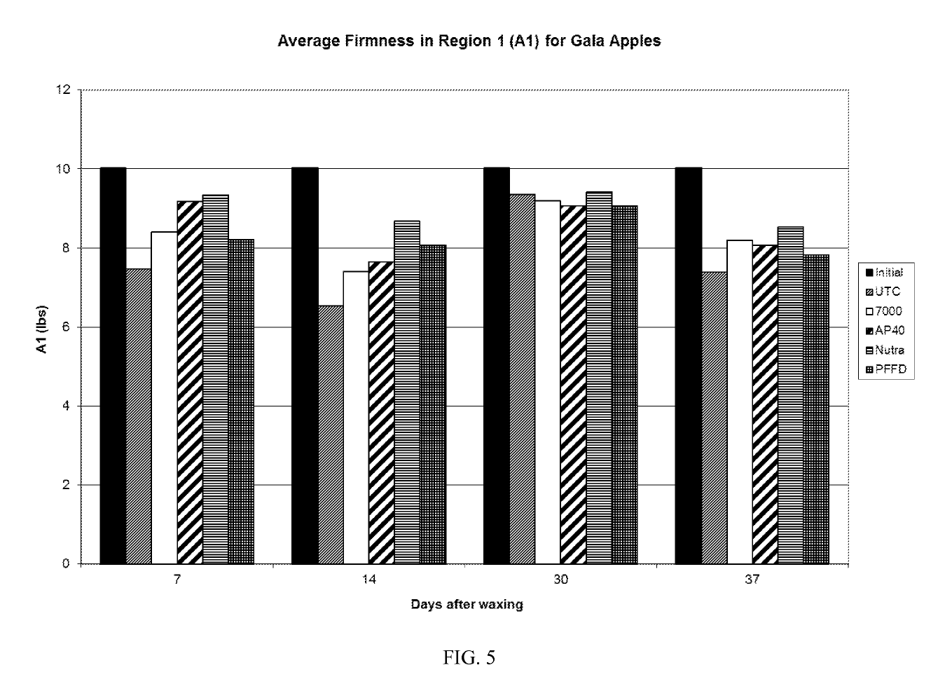

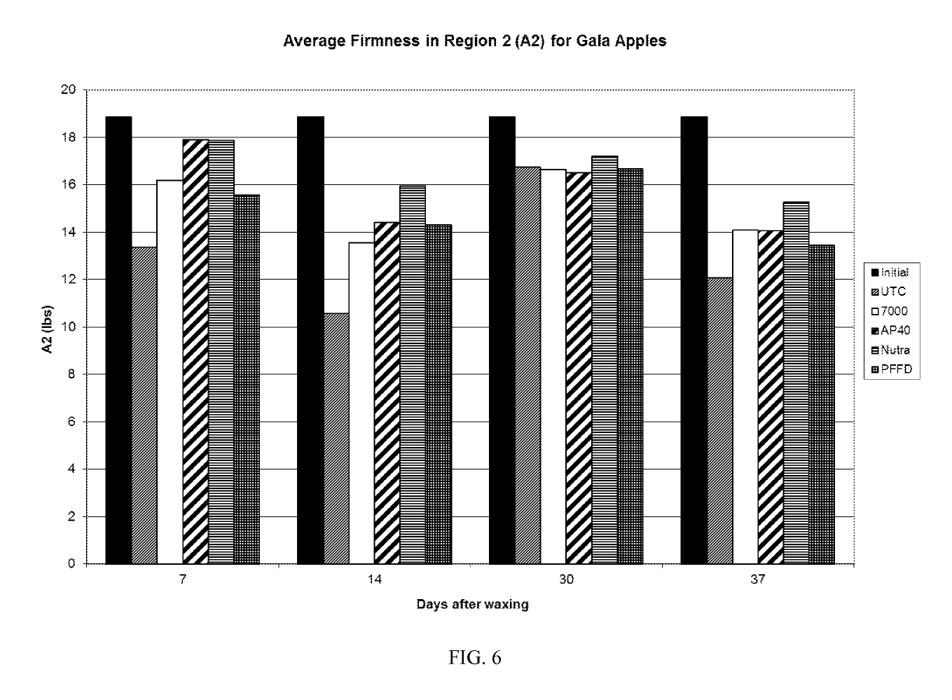

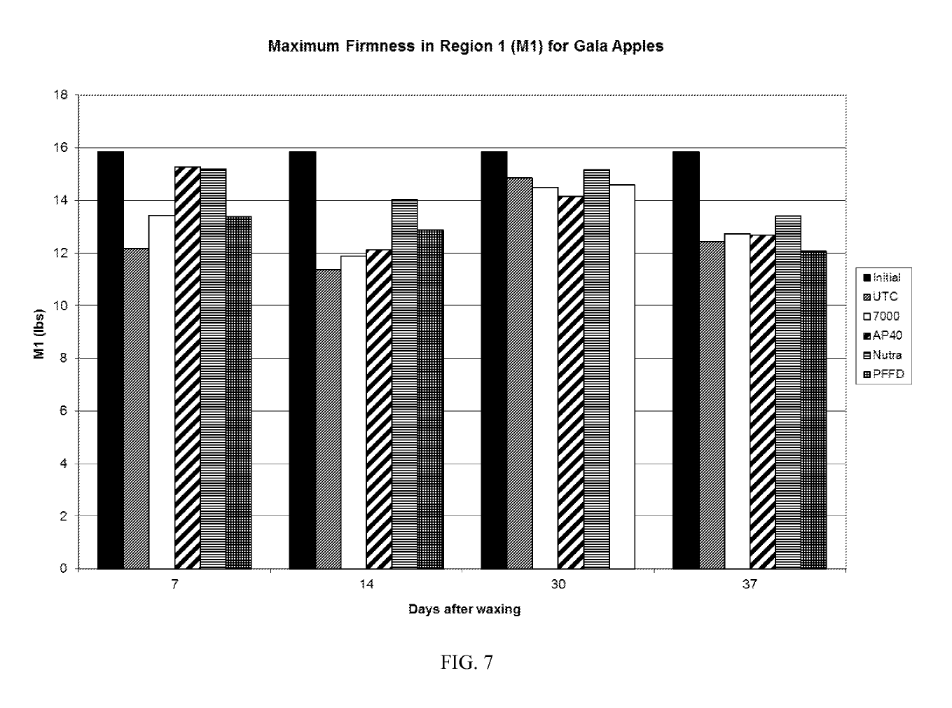

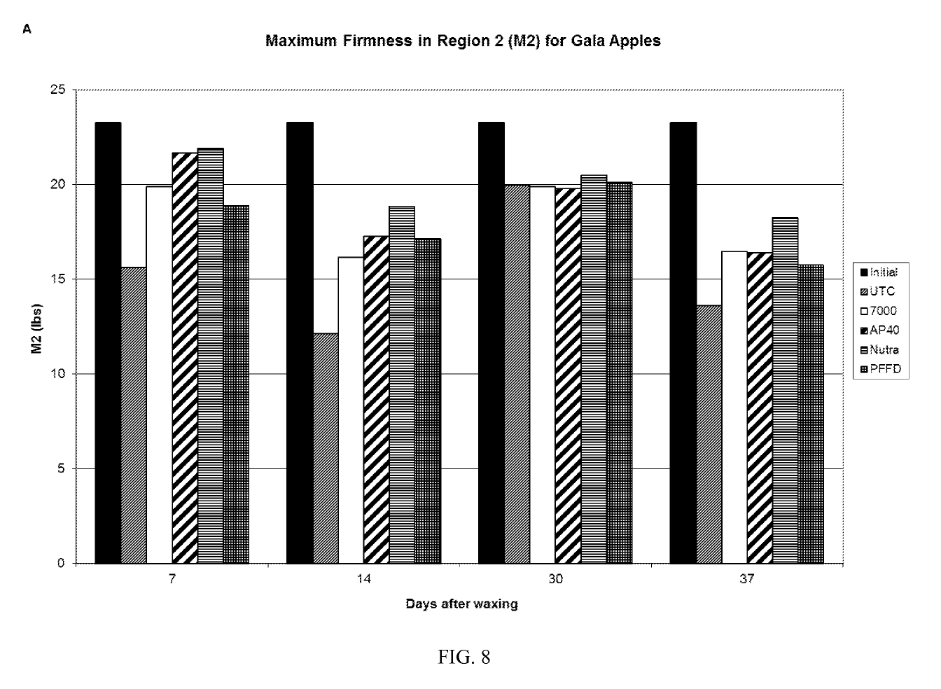

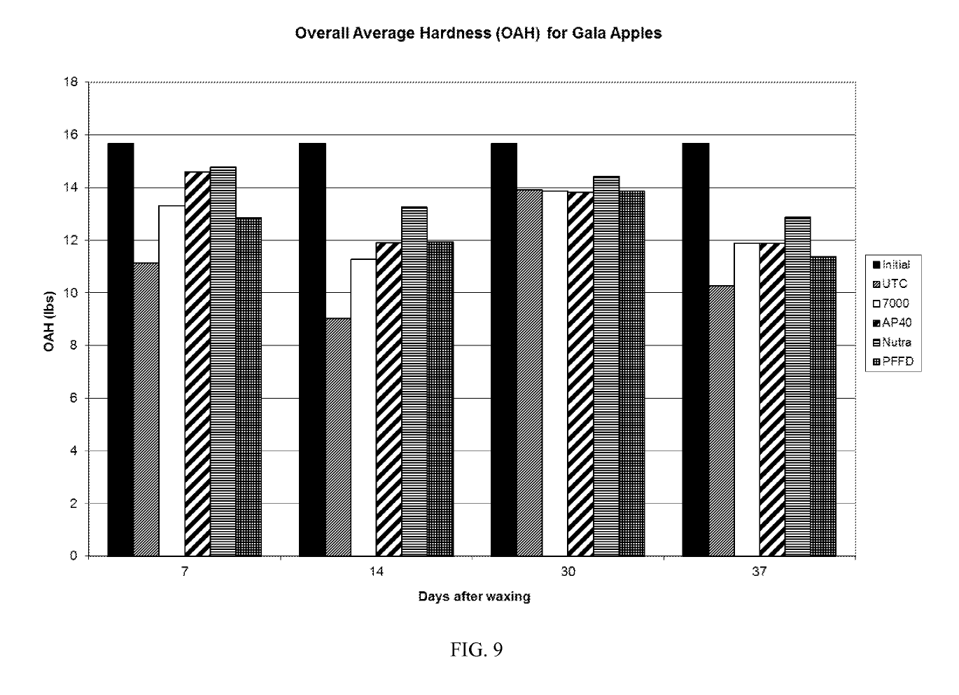

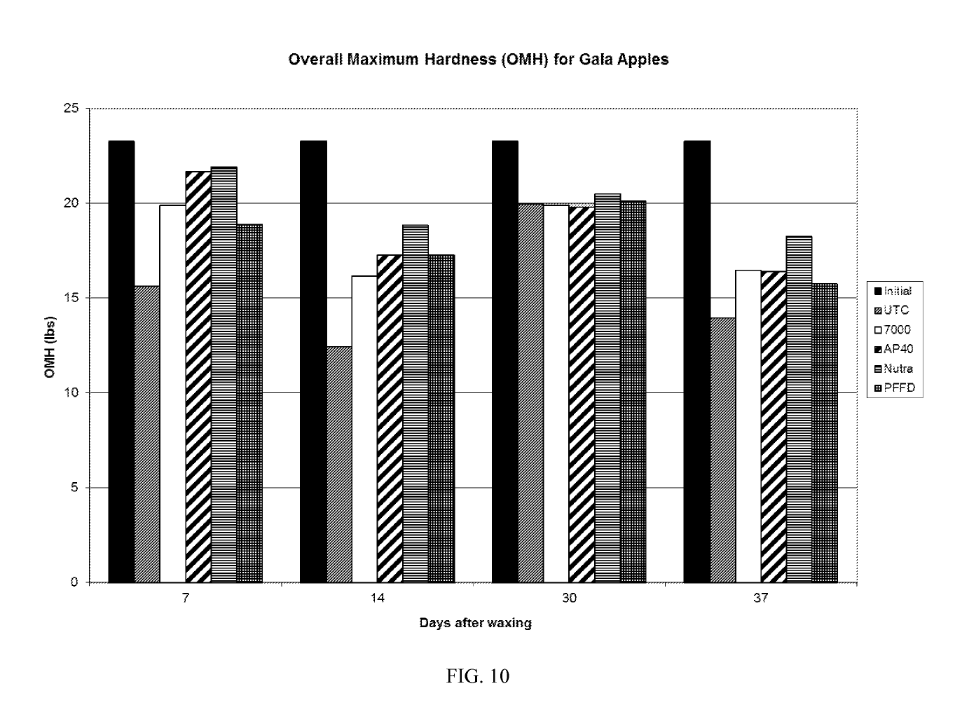

In FIGS. 1-10, “Initial” indicates value at day zero before coatings were applied. UTC is the untreated control (no coating applied). 7000 represents EXC 7000; AP40 represents the SHIELD-BRITE™ AP40 coating; Nutra represents a coating containing a nutraceutical, in this instance, resveratrol; and PFFD represents PRIMAFRESH™ FD.

### Coatings

### EXC-7000

An illustrative carnauba wax emulsion product, also referred to as DURASHINE™. It is a good example of a carnauba coating made for the post-harvest industry. One or more stilbenoid compounds could be added to this formulation, however, in the experiments shown herein, the product was tested without any stilbenoid compounds.

INGREDIENTS: (1) Water; (2) Carnauba Wax; (3) Food-Grade Fatty Acid Soaps, made during the reaction of morpholine and oleic acid, and other fatty acids found in typical commercial food-grade oleic acid; (4) Shellac; (5) Morpholine; and (6) Food-Grade Polydimethylsiloxane Defoamer.

Shield-Brite AP-40

This illustrative shellac solution product is in commercial use in packinghouses. Each company has their own version of this type of a coating; ingredients for such coatings are typically the same with slight variations unique to each company. AP-40 is tested herein without the addition of one or more stilbenoid compounds, however, it is contemplated herein that one or more stilbenoid compounds can be added to this product.

INGREDIENTS: (1) Water; (2) Shellac (lac resin); (3) Morpholine; (4) Oleic Acid; (5) Food-Grade Monopropylene Glycol; (6) Food-Grade Polydimethylsiloxane Defoamer ; and (7) Isopropyl Alcohol.

### PrimaFresh FD

This is a carnauba emulsion product used commercially in packinghouses. It is a good example of a carnauba coating made for the post-harvest industry, and contemplated herein as an illustrative carnauba coating to which one or more stilbenoid compounds can be added.

INGREDIENTS: (1) Water; (2) Carnauba Wax; (3) Food-Grade Fatty Acid Soaps, made from the reaction of morpholine and oleic acid and other fatty acids found in typical commercial food-grade oleic acid; (4) Shellac; (5) Morpholine; and (6) Food-Grade Polydimethylsiloxane Defoamer.

### Nutraceutical Coating—EXC 5150

This illustrative shellac-based coating prototype is made specifically for this disclosure according to some of the aspects described herein. The resveratrol is incorporated directly into the coating during manufacturing of the coating at the coating manufacturing facility. It is not necessary to add the resveratrol to the coating in the packinghouse as it is a stable part of the formulation.

INGREDIENTS: (1) Water; (2) Shellac (lac resin); (3) Isopropyl Alcohol; (4) Morpholine; (5) Resveratrol; (6) Oleic Acid; (7) Monopropylene Glycol; and (8) Food-Grade Polydimethylsiloxane Defoamer.

Fruit Texture Analyses (Crispness, creep, E2, A2, M2, A1, M1, OAH, OMH)

Fruit texture analyses were performed using a Mohr Digi-Test Fruit Texture Analyzer (Mohr and Associates, Richland, Wash.). The Mohr Digi-Test measures crispness, creep, core integrity (E2), maximum firmness in regions 1 and 2 (M1 and M2, respectively), average firmness in regions 1 and 2 (A1 and A2, respectively), overall average hardness (OAH), and overall maximum hardness (OMH). Measurements were obtained on opposite sides of peeled apples using an 11 mm plunger.

### Weight Loss

Weight loss data was obtained by weighing individually numbered apples the day they were waxed (after the wax dried) and on the day of evaluation. The difference between the two weights was calculated and recorded as the weight loss.

### Titratable Acidity

Five milliliters of juice was brought up to a volume of 45 mL with deionized water then titrated to pH 8.2 with 0.1 N KOH using a Metrohm 888 Titrando autotitrator (Metrohm USA Inc., Riverview, Fla.). Malic acid equivalents were calculated and expressed in grams of malic acid per liter of juice.

### Discussion

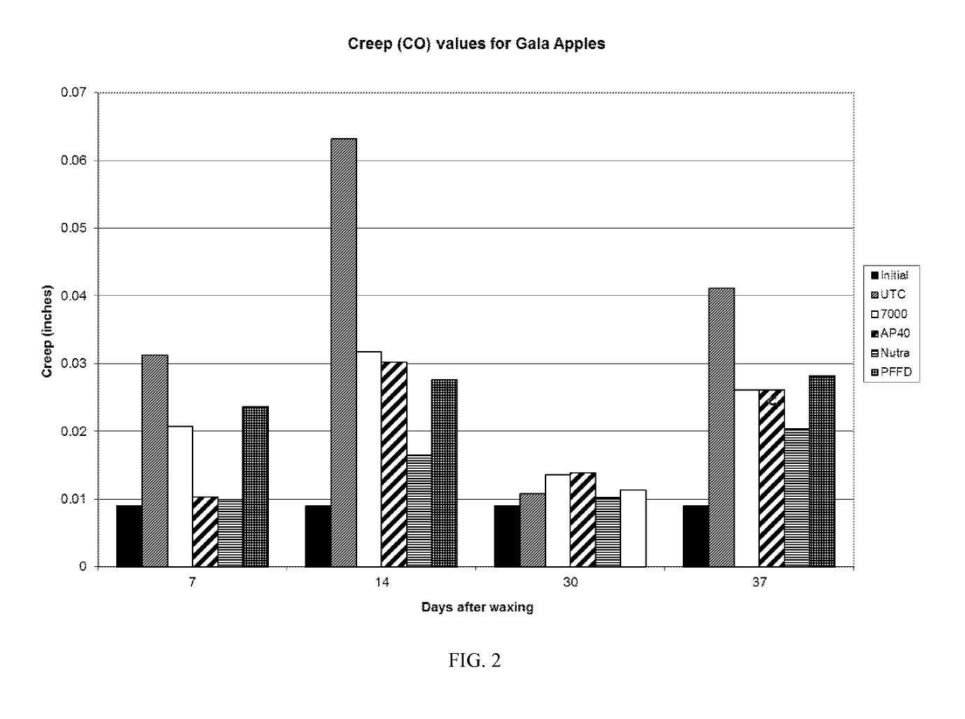

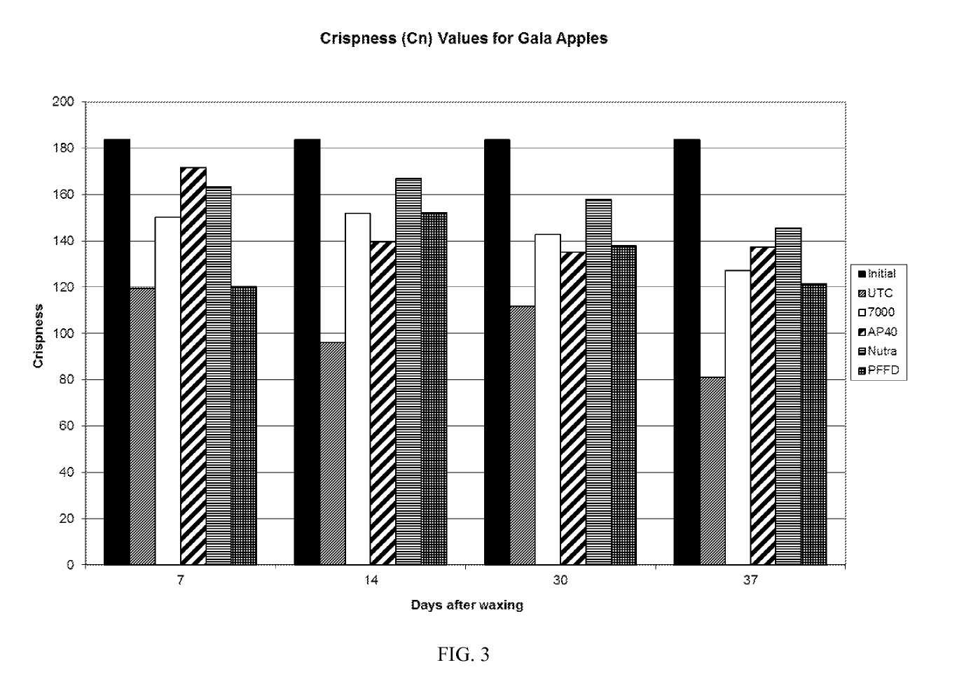

When compared to other coatings the nutraceutical coating which contained resveratrol demonstrated reduced weight loss (FIG. 1), shorter creep distances (FIG. 2), and higher crispness (CN), core integrity (CO), A1, A2, M1, M2, OAH, and OMH values (FIGS. 3-10). These values indicate that the nutraceutical coated apples were higher quality apples that were juicier, crispier, and firmer when compared to uncoated apples as well as apples coated with the other products tested in this experiment.

When introducing elements or features of embodiments herein, the articles “a”, “an”, “the” and “said” are intended to mean that there are one or more of such elements or features. The terms “comprising”, “including”, and “having” are intended to be inclusive and mean that there may be additional elements or features other than those specifically noted. The phrase “consisting essentially of” is intended to limit the scope of a claim to the specified materials or steps and those that do not materially affect the basic and novel characteristic(s) of the claimed subject matter. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure. All references cited herein are incorporated in their entirety by reference.

What is claimed is:

1. A composition comprising a produce coating and one or more stilbenoid compounds.

2. The composition of claim 1, wherein the stilbenoid compound is a stilbene derivative, a stilbene oligomer, stilbene, a stilbenoid derivative, or a stilbenoid oligomer.

3. The composition of claim 2, wherein the compound is selected from the group consisting of resveratrol, pterostilbene, piceid, ε-viniferin, piceatannol, diptoindonesin A, pinosylvin, astringin, vaticanol B, trans-diptoindonesin B, hopeaphenol, hemsleyanol D, gnetin H, ampelopsin A, ampelopsin E, and alpha-viniferein.

4. The composition of claim 1, wherein the produce coating comprises one or more of a wax, oil, resin, protein, carbohydrate, phospholipid, gum, silicone, or polydimethylsiloxane.

5. The composition of claim 1, wherein the produce coating comprises one or more of a carnauba wax, beeswax, candelilla wax, rice bran wax, soy wax, banana leaf wax, sunflower oil, olive oil, corn oil, petroleum oil, petrolatum, mineral oil, wood rosin, shellac, natural resin, or synthetic resins.

6. The composition of claim 1, wherein the composition is formulated for application to the produce by thermofogging.

7. The composition of claim 1, wherein the composition is formulated for application to the produce by drenching.

8. The composition of claim 1, wherein the composition is formulated for application to the produce by brushes or rollers.

9. The composition of claim 1, wherein the composition is formulated for application to the produce by spraying or dripping.

10. A food product comprising a fruit, vegetable, or other edible plant part having a composition applied to the surface, wherein the composition comprises:
i) a wax, oil, resin, protein, carbohydrate, phospholipid, gum, silicone, or polydimethysiloxane; and
ii) one or more compounds selected from the group consisting of resveratrol, stilbene, pterostilbene, piceid, ε-viniferin, piceatannol, diptoindonesin A, pinosylvin, astringin, vaticanol B, trans-diptoindonesin B, hopeaphenol, hemsleyanol D, gnetin H, ampelopsin A, ampelopsin E, and alpha-viniferein.

11. A method of maintaining health of a fruit, vegetable, or other edible plant part, the method comprising contacting the surface of the fruit, vegetable, or other edible plant part with a composition comprising a produce coating and one or more stilbenoid compounds.

12. The method of claim 11, wherein the stilbenoid compound is a stilbene derivative, a stilbene oligomer, stilbene, a stilbenoid derivative, or a stilbenoid oligomer.

13. The method of claim 12, wherein the compound is selected from the group consisting of resveratrol, stilbene, pterostilbene, piceid, ε-viniferin, piceatannol, diptoindonesin A, pinosylvin, astringin, vaticanol B, trans-diptoindonesin B, hopeaphenol, hemsleyanol D, gnetin H, ampelopsin A, ampelopsin E, and alpha-viniferein.

14. The method of claim 11, wherein the produce coating comprises one or more of a wax, oil, resin, protein, carbohydrate, phospholipid, gum, silicone, or polydimethysiloxane.

15. The method of claim 11, wherein the produce coating comprises one or more of a carnauba wax, beeswax, candelilla wax, sunflower oil, olive oil, corn oil, petroleum oil, petrolatum, mineral oil, wood rosin, shellac, natural resin, or synthetic resins.

16. The method of claim 11, wherein the fruit, vegetable, or other edible plant part is a stone fruit, a pome fruit, or berries.

17. A method of mitigating decay of post-harvest produce, the method comprising contacting the surface of the produce with a composition comprising a produce coating and one or more stilbenoid compounds.

18. The method of claim 17, wherein the stilbene compound is a stilbene derivative, a stilbene oligomer, a stilbenoid compound, a stilbenoid derivative, or a stilbenoid oligomer.

19. The method of claim 18, wherein the compound is selected from the group consisting of resveratrol, pterostilbene, piceid, ε-viniferin, piceatannol, diptoindonesin A, pinosylvin, astringin, vaticanol B, trans-diptoindonesin B, hopeaphenol, hemsleyanol D, gnetin H, ampelopsin A, ampelopsin E, and alpha-viniferein.

20. The method of claim 17, wherein the produce coating comprises one or more of a wax, oil, resin, protein, carbohydrate, phospholipid, gum, silicone, or polydimethysiloxane.

21. The method of claim 17, wherein the produce coating comprises one or more of a carnauba wax, beeswax, candelilla wax, sunflower oil, olive oil, corn oil, petroleum oil, petrolatum, mineral oil, wood rosin, shellac, natural resin, or synthetic resins.

22. The method of claim 17, wherein the produce is a stone fruit, a pome fruit, or berries.

23. A method of maintaining firmness of a stone fruit, a pome fruit, or berries after harvest, the method comprising contacting the surface of the fruit or berries with a composition comprising resveratrol and a fruit coating selected from carnauba and shellac.
